(19) United States
(12) Patent Application Publication
(10) Pub. No.: US 2025/0029394 A1
(43) Pub. Date: Jan. 23, 2025

(54) METHOD AND SYSTEM FOR DETECTING RETAINING WALL SUITABLE FOR AUTOMATIC DRIVING VEHICLE

(71) Applicant: JiangSu XCMG Construction Machinery Research Institute LTD., Jiangsu (CN)

(72) Inventors: Bin Zhao, Jiangsu (CN); Jinming LI, Jiangsu (CN); Jianlin TANG, Jiangsu (CN)

(73) Assignee: JiangSu XCMG Construction Machinery Research Institute LTD., Jiangsu (CN)

(21) Appl. No.: 18/710,619

(22) PCT Filed: Feb. 21, 2022
(86) PCT No.: PCT/CN2022/076996

§ 371 Date: May 16, 2024

(30) Foreign Application Priority Data
Nov. 26, 2021 (CN) 202111424522.0

(51) Int. Cl. G06V 20/58; B60W 40/02; G06V 10/40

(52) U.S. Cl. CPC G06V 20/58; B60W 40/02; G06V 10/40; B60W 2554/20; B60W 2554/802

(57) ABSTRACT

The invention discloses a method and system for detecting a retaining wall suitable for an automatic driving vehicle. The method comprises: obtaining original data acquired during a backing process of a vehicle and used for detecting a retaining wall, and processing the original data to obtain finally processed data of the retaining wall; obtaining ground data during the backing process of the vehicle, and sequentially performing ground determination and ground elimination on the ground data to obtain non-ground point cloud data; and obtaining distance information between a rear end of the vehicle and the retaining wall and integrity data of the retaining wall by calculation according to the finally processed data of the retaining wall and the non-ground point cloud data.

### TECHNICAL FIELD

The invention relates to a method and system for detecting a retaining wall suitable for an automatic driving vehicle, and belongs to the technical field of engineering machines.

### BACKGROUND

The rise of big data, 5G, artificial intelligence and other emerging techniques provides an opportunity for comprehensive intelligent transformation and upgrading of the mining industry. During on-site construction, vehicles may face the following three problems:

First, when vehicles are backed in an unloading region to unload materials, how to accurately perceive the position and shape of a retaining wall to ensure that the vehicles will not move beyond the boundary of the region while dumping the materials out of the unloading region;

Second, when vehicles are backed in, because the perception system on the rear side of the vehicles has a blind zone with a certain range, how to avoid a collision between the vehicles and a small-sized ground obstacle behind the vehicles to guarantee driving safety:

Third, when vehicles are driven normally, because the perception system on the front side of the vehicles has a blind zone with a certain range, how to avoid a collision between the vehicles and a small-sized ground obstacle in front of the vehicles to guarantee driving safety.

Although some image-based target detection or target segmentation algorithms, including traditional methods and deep learning-based methods, have nowadays been widely used for detecting urban road obstacles. However, up to now, there is little study on detection of retaining walls and ground obstacles behind vehicles in mining areas.

For laser point clouds, considering the complexity of urban road scenes, a neural network-based or deep learning-based perception scheme is commonly used for driverless vehicles. However, compared with urban road scenes, the unloading scenes in the mining areas are relatively simple, and the number of obstacles is small, so some traditional rule-based algorithms can be used in these scenes, two common ones of which are a grid-based algorithm and a pole figure-based algorithm. The grid-based algorithm distinguishes obstacle points from ground points generally based on a fixed altitude difference threshold. The pole figure-based algorithm distinguishes obstacle points from ground points based on an obtained desired ground altitude according to a fitted relationship between distances and desired ground altitude.

Existing methods for detecting retaining walls and obstacles behind vehicles still have some problems and limitations:
(1) Image-based algorithm: because images are sensitive to the illumination condition and the visibility in mining areas is low due to the existence of a large amount of dust, the image quality will be greatly reduced, compromising detection results; in addition, the lack of a large volume of image data related to the mining areas at present makes it impossible to adopt image detection based on deep learning: moreover, one of the tasks of perception is to acquire position information of related obstacles, and it is difficult to obtain spatial distance information of obstacles from images by direct calculation, so the requirement for perceiving targets in the mining areas cannot satisfied merely by means of image data.
(2) Laser point cloud-based algorithm: although it has been proved that the detection performance of the point cloud-based deep learning algorithm is better than that of traditional rule-based algorithms, the time cost and economic cost of the point cloud-based deep learning algorithm in data calibration and model training are high, leading to a low cost performance when the point cloud-based deep learning algorithm is applied to scenes in mining areas; the traditional rule-based algorithms, such as the grid-based algorithm, easily result in false detection and detection omissions due to the use of a simple altitude difference threshold when applied to mining areas where the ground altitudes are different, and the pole figure-based algorithm cannot eliminate floating noisy points.

### SUMMARY

The technical issue to be settled by the invention is to overcome the defects in the prior art by providing a method and system for detecting a retaining wall suitable for an automatic driving vehicle. When a vehicle is backed in, the system can detect and output distance information between the rear end of the vehicle and a retaining wall (small-sized ground obstacle) and integrity information of the retaining wall in real time, thus guaranteeing the safety during the backing process of the vehicle.

To settle the above technical issue, the invention provides a method for detecting a retaining wall suitable for an automatic driving vehicle, comprising:
obtaining original data acquired during a backing process of a vehicle and used for detecting a retaining wall, and sequentially performing filtering, dilation, coordinate transformation, clipping and noisy point elimination on the original data to obtain finally processed data of the retaining wall;
obtaining ground data during the backing process of the vehicle, and sequentially performing ground determination and ground elimination on the ground data to obtain non-ground point cloud data; and
obtaining distance information between a rear end of the vehicle and the retaining wall and integrity data of the retaining wall by calculation according to the finally processed data of the retaining wall and the non-ground point cloud data.

Further, the original data are data acquired by a vehicle sensor system, the vehicle sensor system comprises a combinatorial navigation unit and a single-threaded laser radar unit, the combinatorial navigation unit is used for acquiring and outputting attitude information and motion state information of the vehicle, and the single-threaded laser radar unit is used for acquiring and outputting point cloud data related to the retaining wall behind the automatic driving vehicle.

Further, sequentially performing filtering, dilation, coordinate transformation, clipping and noisy point elimination on the original data to obtain finally processed data of the retaining wall comprises:
determining, according to the original data, whether a distance from a coordinate of a point in a laser-radar point cloud to a coordinate origin is less than a preset distance; if so, determining the point indicated by the coordinate as an invalid point that needs to be filtered out;
otherwise, determining the point indicated by the coordinate as a valid point that needs to be reserved;
performing dilation transformation on coordinates of data obtained after invalid points in the vicinity of the coordinate origin are filtered out from the point cloud;
performing orthogonal transformation on the data subjected to dilation transformation to transform a reference system of the data subjected to dilation transformation from a sensor coordinate system to a vehicle coordinate system;
determining, according to size parameters of the vehicle, whether a coordinate of a point after orthogonal transformation belongs to a vehicle body; if so, determining the point indicated by the coordinate as an invalid point that needs to be filtered out; otherwise, determining the point indicated by the coordinate is a valid point that needs to be reserved; and
determining whether a point left after invalid points belonging to the vehicle body are filtered out is a noisy point according to a change in attribute of the point; if so, filtering out of the noisy point, thus obtaining the final processed data of the retaining wall.

Further, sequentially performing ground determination and ground elimination on the ground data to obtain non-ground point cloud data comprises:
sequentially obtaining geometric features of an area where projections on a ground of points in the point cloud are located according to the ground data, and determining whether the points are ground points according to the geometric features of the area; if so, filtering out of the points; otherwise, reserving the points, thus obtaining point cloud data of non-ground point information; and
constructing and outputting the non-ground point cloud data according to the point cloud data of the non-ground point information.

Further, obtaining distance information between a rear end of the vehicle and the retaining wall and integrity data of the retaining wall by calculation according to the finally processed data of the retaining wall and the non-ground point cloud data comprises:
converting the non-ground point cloud data into a well-ordered set according to a preset well-ordered relationship, and creating necessary geometric elements according to the finally processed data of the retaining wall and the size parameters of the vehicle;
calculating the distance information between the rear end of the vehicle and the retaining wall according to the well-ordered set and the necessary geometric elements; and
determining the integrity data of the retaining wall behind the vehicle according to the well-ordered set, the necessary geometric elements and the distance information between the rear end of the vehicle and the retaining wall.

Further, the well-ordered relationship is expressed as:

$${\vec{p}}_{1} > {\vec{p}}_{2} ⇔ ( sign ( ( {\vec{p}}_{1} \times {\vec{p}}_{2} ) \vert z ) 〈 {\vec{p}}_{1} , {\vec{p}}_{2} 〉 > 0 ) ⋁ ( ( {\vec{p}}_{1} \times {\vec{p}}_{2} = \vec{0} ) ∧ ( \vert {\vec{p}}_{1} \vert > \vert {\vec{p}}_{2} \vert ) )$$

$$wherein ,$$

$$sign ( x ) = \{ \begin{matrix}1 & x \geq 0 \\ - 1 & x < 0\end{matrix}$$

where, \vec{p}₁ and \vec{p}₂ denote position vectors corresponding to coordinates of any two points in the point cloud, z denotes a Z-axis, \vec{0} denotes a zero vector, x is an independent variable, and x=(\vec{p}₁×\vec{p}₂)|z.

Further, the necessary geometric elements comprise:
a plane α located at the rear end of the vehicle and perpendicular to a chassis of the vehicle;
a plane β₁ located at a center of a rear left wheel of the vehicle and perpendicular to a rear axle of the vehicle;
a plane β₂ located at a center of a rear right wheel of the vehicle and perpendicular to the rear axle of the vehicle;
a plane γ₁₁ located on an inner side of the rear left wheel of the vehicle and perpendicular to the rear axle of the vehicle;
a plane γ₁₂ located on an outer side of the rear left wheel of the vehicle and perpendicular to the rear axle of the vehicle;
a plane γ₂₁ located on an inner side of the rear right wheel of the vehicle and perpendicular to the rear axle of the vehicle; and
a plane γ₂₂ located on an outer side of the rear right wheel of the vehicle and perpendicular to the rear axle of the vehicle.

Further, calculating the distance information between the rear end of the vehicle and the retaining wall according to the well-ordered set and the necessary geometric elements comprises:
searching out a point nearest the plane β₂ from the well-ordered set, and calculating a distance between the point and the plane α to obtain a distance from the rear right wheel of the vehicle to the retaining wall;
selecting points between the plane γ₂₁ and the plane γ₂₂ from the well-ordered set, then searching out a point nearest the plane α from the selected points, and calculating a distance between the point and the plane α to obtain a minimum distance from the rear right wheel of the vehicle to the retaining wall;
searching out a point nearest the plane α from the well-ordered set, and calculating a distance between the point and the plane α to obtain a distance from the rear end of the vehicle to the retaining wall;
selecting points between the plane γ₁₁ and the plane γ₁₂ from the well-ordered set, then searching out a point nearest the plane α from the selected points, and calculating a distance between the point and the plane α to obtain a minimum distance from the rear left wheel of the vehicle to the retaining wall; and
searching out a point nearest the plane β₁ from the well-ordered set, and calculating a distance between the point and the plane α to obtain a distance from the rear left wheel of the vehicle to the retaining wall.

Further, determining the integrity data of the retaining wall behind the vehicle according to the well-ordered set, the necessary geometric elements and the distance information between the rear end of the vehicle and the retaining wall comprises:
determining points, with a distance to the plane α exceeding a first preset threshold, in the well-ordered set as abnormal points, calculating the proportion of the abnormal points in all points in the well-ordered set, and determining according to a first criterion; if the proportion is greater than a preset proportion threshold, determining the retaining wall as incomplete; or, if the proportion is not greater than the preset proportion threshold, eliminating the abnormal points from the well-ordered set;
after the abnormal points are eliminated, determining according to a second criterion, a third criterion and a fourth criterion;
the second criterion: determining whether a mean square root of a distance between projections, on the plane α, of two adjacent points in the well-ordered set is within the range of a second preset threshold;
the third criterion: determining whether a standard deviation of distances from all the points in the well-ordered set to the plane α is within the range of a third preset threshold;
the fourth criterion: determining whether there are points, with a distance therebetween within the range of a fourth preset threshold, on two sides of the plane β₁ and two sides of the plane β₂; and
determining the retaining wall as complete when the proportion of the abnormal points is not greater than the preset proportion threshold and the second criterion, the third criterion and the fourth criterion are satisfied.

A system for detecting a retaining wall suitable for an automatic driving vehicle, comprising:
a data acquisition module used for obtaining original data acquired during a backing process of a vehicle and used for detecting a retaining wall, and sequentially performing filtering, dilation, coordinate transformation, clipping and noisy point elimination on the original data to obtain finally processed data of the retaining wall;
a data screening module used for obtaining ground data during the backing process of the vehicle, and sequentially performing ground determination and ground elimination on the original data to obtain non-ground point cloud data; and
a feature extraction module used for obtaining distance information between a rear end of the vehicle and the retaining wall and integrity data of the retaining wall by calculation according to the finally processed data of the retaining wall and the non-ground point cloud data.

The invention has the following beneficial effects:

First, when a vehicle is backed in an unloading region to unload materials, distance information between the vehicle and a retaining wall behind the vehicle can be accurately detected, and integrity information of the retaining wall behind the vehicle can be perceived, thus ensuring that the vehicle will not move across the boundary of an unloading region when dumping materials out of the unloading region:

Second, when a vehicle is backed in, the distance between the vehicle and a small-sized ground obstacle behind the vehicle can be accurately detected to avoid a collision between the back side of the vehicle and the obstacle, thus guaranteeing driving safety:

Third, when a vehicle is driven normally, the distance between the vehicle and a small-sized ground obstacle in front of the vehicle can be accurately detected to avoid a collision between the front side of the vehicle and the obstacle, thus guaranteeing driving safety.

### BRIEF DESCRIPTION OF THE DRAWINGS

FIG. 1 is an overall flow diagram according to the invention;

FIG. 2 is an overall schematic diagram of a system according to the invention;

FIG. 3 is a schematic diagram of a data acquisition module:

FIG. 4 is a schematic diagram of a data screening module:

FIG. 5 illustrates a feature extraction module:

FIG. 6a and FIG. 6b are schematic diagrams for explaining a well-ordered relationship defined by a data processing submodule:

FIG. 7 is a schematic distribution diagram of necessary geometric elements established by the data processing submodule:

FIG. 8 is a schematic distribution diagram of distance information between the rear end of a vehicle and a retaining wall;

FIG. 9a is a schematic diagram of a working condition corresponding to a first criterion for determining the integrity of a retaining wall;

FIG. 9b is a schematic diagram of a working condition corresponding to a second criterion for determining the integrity of a retaining wall;

FIG. 9c is a schematic diagram of a working condition corresponding to a third criterion for determining the integrity of a retaining wall;

FIG. 9d is a schematic diagram of a working condition corresponding to a fourth criterion for determining the integrity of a retaining wall.

### DESCRIPTION OF THE EMBODIMENTS

The invention will be further described below in conjunction with accompanying drawings. The following embodiments are merely used for more clearly explaining the technical solutions of the invention and are not intended to limit the protection scope of the invention.

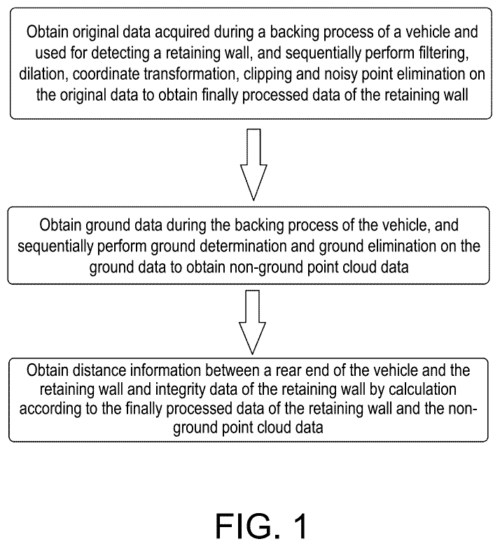

As shown in FIG. 1, the invention provides a method for detecting a retaining wall suitable for an automatic driving vehicle, comprising obtaining original data acquired during a backing process of a vehicle and used for detecting a retaining wall, and sequentially performing filtering, dilation, coordinate transformation, clipping and noisy point elimination on the original data to obtain finally processed data of the retaining wall;
obtaining ground data during the backing process of the vehicle, and sequentially performing ground determination and ground elimination on the ground data to obtain non-ground point cloud data; and
obtaining distance information between a rear end of the vehicle and the retaining wall and integrity data of the retaining wall by calculation according to the finally processed data of the retaining wall and the non-ground point cloud data.

Further, the original data are data acquired by a vehicle sensor system, the vehicle sensor system comprises a combinatorial navigation unit and a single-threaded laser radar unit, the combinatorial navigation unit is used for acquiring and outputting attitude information and motion state information of the vehicle, and the single-threaded laser radar unit is used for acquiring and outputting point cloud data related to the retaining wall behind the automatic driving vehicle.

Further, sequentially performing filtering, dilation, coordinate transformation, clipping and noisy point elimination on the original data to obtain finally processed data of the retaining wall comprises:
determining, according to the original data, whether a distance from the coordinate of a point in a laser-radar point cloud to a coordinate origin is less than a preset distance; if so, determining the point indicated by the coordinate as an invalid point that needs to be filtered out; otherwise, determining the point indicated by the coordinate as a valid point that needs to be reserved;
performing dilation transformation on coordinates of data obtained after invalid points in the vicinity of the coordinate origin are filtered out from the point cloud;
performing orthogonal transformation on the data subjected to dilation transformation to transform a reference system of the data subjected to dilation transformation from a sensor coordinate system to a vehicle coordinate system;
determining, according to size parameters of the vehicle, whether the coordinate of a point after orthogonal transformation belongs to a vehicle body; if so, determining the point indicated by the coordinate as an invalid point that needs to be filtered out; otherwise, determining the point indicated by the coordinate is a valid point that needs to be reserved; and
determining whether a point left after invalid points belonging to the vehicle body are filtered out is a noisy point according to a change in attribute of the point; if so, filtering out of the noisy point, thus obtaining the final processed data of the retaining wall.

Further, sequentially performing ground determination and ground elimination on the ground data to obtain non-ground point cloud data comprises:
sequentially obtaining geometric features of an area where projections on the ground of points in the point cloud are located according to the ground data, and determining whether the points are ground points according to the geometric features of the area; if so, filtering out of the points; otherwise, reserving the points, thus obtaining point cloud data of non-ground point information; and
constructing and outputting the non-ground point cloud data according to the point cloud data of the non-ground point information.

Further, obtaining distance information between a rear end of the vehicle and the retaining wall and integrity data of the retaining wall by calculation according to the finally processed data of the retaining wall and the non-ground point cloud data comprises:
converting the non-ground point cloud data into a well-ordered set according to a preset well-ordered relationship, and creating necessary geometric elements according to the finally processed data of the retaining wall and the size parameters of the vehicle;
calculating the distance information between the rear end of the vehicle and the retaining wall according to the well-ordered set and the necessary geometric elements; and
determining the integrity data of the retaining wall behind the vehicle according to the well-ordered set, the necessary geometric elements and the distance information between the rear end of the vehicle and the retaining wall.

Further, the well-ordered relationship is expressed as:

$${\vec{p}}_{1} > {\vec{p}}_{2} ⇔ ( sign ( ( {\vec{p}}_{1} \times {\vec{p}}_{2} ) \vert z ) 〈 {\vec{p}}_{1} , {\vec{p}}_{2} 〉 > 0 ) ⋁ ( ( {\vec{p}}_{1} \times {\vec{p}}_{2} = \vec{0} ) ∧ ( \vert {\vec{p}}_{1} \vert > \vert {\vec{p}}_{2} \vert ) )$$

$$wherein ,$$

$$sign ( x ) = \{ \begin{matrix}1 & x \geq 0 \\ - 1 & x < 0\end{matrix}$$

where, \vec{p}₁ and \vec{p}₂ denote position vectors corresponding to coordinates of any two points in the point cloud, z denotes a Z-axis, \vec{0} denotes a zero vector, x is an independent variable, and x=(\vec{p}₁×\vec{p}₂)|z.

Further, the necessary geometric elements comprise:
a plane α located at the rear end of the vehicle and perpendicular to a chassis of the vehicle;
a plane β₁ located at the center of a rear left wheel of the vehicle and perpendicular to a rear axle of the vehicle;
a plane β₂ located at the center of a rear right wheel of the vehicle and perpendicular to the rear axle of the vehicle;
a plane γ₁₁ located on an inner side of the rear left wheel of the vehicle and perpendicular to the rear axle of the vehicle;
a plane γ₁₂ located on an outer side of the rear left wheel of the vehicle and perpendicular to the rear axle of the vehicle;
a plane γ₂₁ located on an inner side of the rear right wheel of the vehicle and perpendicular to the rear axle of the vehicle; and
a plane γ₂₂ located on an outer side of the rear right wheel of the vehicle and perpendicular to the rear axle of the vehicle.

Further, calculating the distance information between the rear end of the vehicle and the retaining wall according to the well-ordered set and the necessary geometric elements comprises: searching out a point nearest the plane β₂ from the well-ordered set, and calculating a distance between the point and the plane α to obtain a distance from the rear right wheel of the vehicle to the retaining wall;
selecting points between the plane γ₂₁ and the plane γ₂₂ from the well-ordered set, then searching out a point nearest the plane α from the selected points, and calculating a distance between the point and the plane α to obtain a minimum distance from the rear right wheel of the vehicle to the retaining wall;
searching out a point nearest the plane α from the well-ordered set, and calculating a distance between the point and the plane α to obtain a distance from the rear end of the vehicle to the retaining wall;
selecting points between the plane γ₁₁ and the plane γ₁₂ from the well-ordered set, then searching out a point nearest the plane α from the selected points, and calculating a distance between the point and the plane α to obtain a minimum distance from the rear left wheel of the vehicle to the retaining wall; and
searching out a point nearest the plane β₁ from the well-ordered set, and calculating a distance between the point and the plane α to obtain a distance from the rear left wheel of the vehicle to the retaining wall.

Further, determining the integrity data of the retaining wall behind the vehicle according to the well-ordered set, the necessary geometric elements and the distance information between the rear end of the vehicle and the retaining wall comprises:
determining points, with a distance to the plane α exceeding a first preset threshold, in the well-ordered set as abnormal points, calculating the proportion of the abnormal points in all points in the well-ordered set, and determining according to a first criterion; if the proportion is greater than a preset proportion threshold, determining the retaining wall as incomplete; or, if the proportion is not greater than the preset proportion threshold, eliminating the abnormal points from the well-ordered set;
after the abnormal points are eliminated, determining according to a second criterion, a third criterion and a fourth criterion;
the second criterion: determining whether a mean square root of a distance between projections, on the plane α, of two adjacent points in the well-ordered set is within the range of a second preset threshold;
the third criterion: determining whether a standard deviation of distances from all the points in the well-ordered set to the plane α is within the range of a third preset threshold;
the fourth criterion: determining whether there are points, with a distance therebetween within the range of a fourth preset threshold, on two sides of the plane β₁ and two sides of the plane β₂; and
determining the retaining wall as complete when the proportion of the abnormal points is not greater than the preset proportion threshold and the second criterion, the third criterion and the fourth criterion are satisfied.

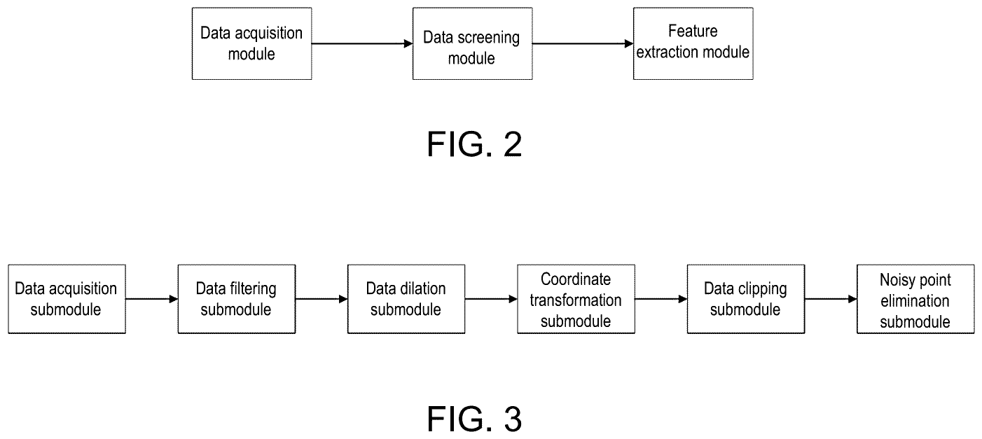

As shown in FIG. 2, correspondingly, the invention further provides a system for detecting a retaining wall suitable for an automatic driving vehicle, comprising a data acquisition module, a data screening module and a feature extraction module.

The data acquisition module is used for acquiring and processing original data used for detecting a retaining wall during a backing process of a vehicle.

The data screening module is used for determining whether there are points, located on the ground, in a point cloud of the data acquisition module during the backing process of the vehicle.

The feature extraction module is used for obtaining distance information between a rear end of the vehicle and the retaining wall and integrity data of the retaining wall by calculation according to data information from the data screening module during the backing process of the vehicle.

As shown in FIG. 3, in one embodiment of the invention, the data acquisition module may comprise a data acquisition submodule, a data filtering submodule, a data dilation submodule, a coordinate transformation submodule, a data clipping submodule and a noisy point elimination submodule.

The data acquisition submodule is used for reading and analyzing in time original data from a vehicle sensor system during the backing process of the vehicle.

The data filtering submodule is used for determining whether the coordinates of points from a laser-radar point cloud are in the vicinity of a coordinate origin to filter out invalid points in the vicinity of the coordinate origin from the point cloud during the backing process of the vehicle.

The data dilation submodule is used for performing dilation transformation on an output result of the data filtering submodule according to internal parameters of a laser-radar during the backing process of the vehicle.

The coordinate transformation submodule is used for performing orthogonal transformation on an output result of the data dilation submodule to transform a reference system of the output result of the data dilation submodule from a sensor coordinate system to a vehicle coordinate system during the backing process of the vehicle.

The data clipping submodule is used for determining, according to size parameters of the vehicle, whether points in an output result of the coordinate transformation submodule belong to a vehicle body to filter out invalid points belonging to the vehicle body during the backing process of the vehicle.

The noisy point elimination submodule is used for determining whether points in an output result of the data clipping submodule are noisy points according to a change in attribute (such as the intensity of reflection) of the points to eliminate noisy points during the backing process of the vehicle.

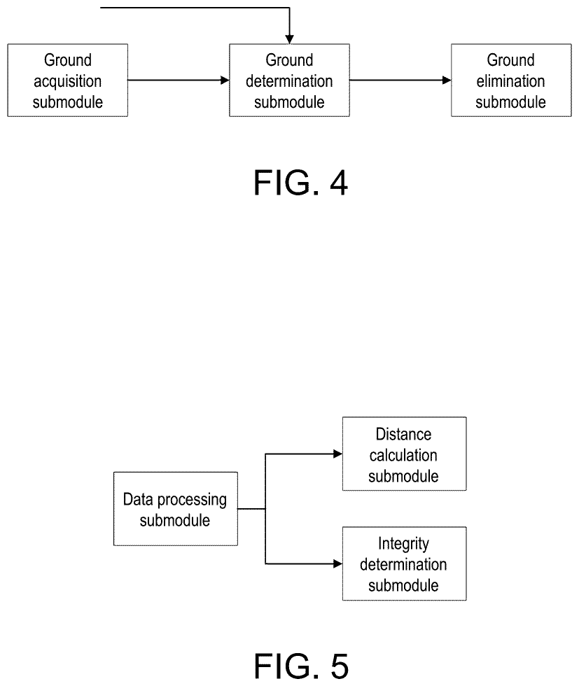

As shown in FIG. 4, in one embodiment of the invention, the data screening module may comprise a ground acquisition submodule, a ground determination submodule and a ground elimination submodule.

The ground acquisition submodule is used for obtaining ground data during the backing process of the vehicle. In one embodiment of the invention, the ground data may be expressed by a set, elements in which may be lines or planes denoting geometric features of an area on the ground.

The ground determination submodule is used for sequentially obtaining geometric features of an area where projections on the ground of points in the point cloud are located according to the ground data and determining whether the points are ground points according to the geometric features of the area during the backing process of the vehicle.

The ground elimination submodule is used for constructing and outputting a non-ground point cloud according to a determination result of the ground determination submodule during the backing process of the vehicle.

As shown in FIG. 5, in one embodiment of the invention, the feature extraction module may comprise a data processing submodule, a distance calculation submodule and an integrity determination submodule.

The data processing submodule is used for converting the point cloud from the data screening module into a well-ordered set A according to a preset well-ordered relationship and creating necessary geometric elements according to the size parameters of the vehicle during the backing process of the vehicle.

The distance calculation submodule is used for obtaining the distance information between the rear end of the vehicle and the retaining wall by calculation according a result of the data processing submodule during the backing process of the vehicle.

The integrity determination submodule is used for determining whether the retaining wall behind the vehicle is complete according to the result of the data processing submodule during the backing process of the vehicle.

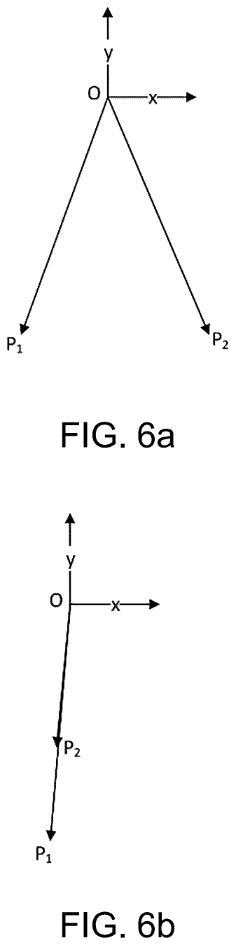

As shown in FIG. 5, FIG. 6a and FIG. 6b, in one embodiment of the invention, the data processing submodule defines the well-ordered relationship as follows to convert the point cloud from the data screening module into the well-ordered set.

Assume \vec{p}₁=\vec{OP₁}, \vec{p}₂=\vec{OP₂}, if \vec{p}₁>\vec{p}₂, there area the following two cases:

First, as shown by FIG. 6a, if \vec{p}₁×\vec{P}₂≠\vec{0}. \vec{p}₁>\vec{p}₂⇔sign ((\vec{p}₁×\vec{p}₂)|z)(\vec{p}₁,\vec{p}₂)>0;

Second, as shown in FIG. 6b, if \vec{p}₁×\vec{p}₂=\vec{0}. \vec{p}₁>\vec{p}₂⇔|\vec{p}₁|>\vec{p}₂|.

To sum up, the defined well-ordered relationship can be expressed as:

$${\vec{p}}_{1} > {\vec{p}}_{2} ⇔ ( sign ( ( {\vec{p}}_{1} \times {\vec{p}}_{2} ) \vert z ) 〈 {\vec{p}}_{1} , {\vec{p}}_{2} 〉 > 0 ) ⋁ ( ( {\vec{p}}_{1} \times {\vec{p}}_{2} = \vec{0} ) ∧ ( \vert {\vec{p}}_{1} \vert > \vert {\vec{p}}_{2} \vert ) )$$

$$wherein ,$$

$$sign ( x ) = \{ \begin{matrix}1 & x \geq 0 \\ - 1 & x < 0\end{matrix} .$$

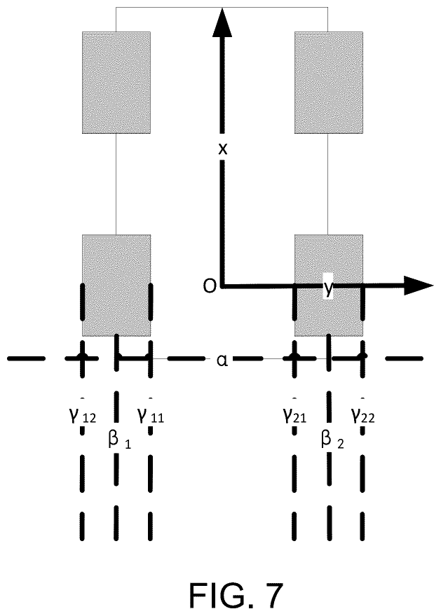

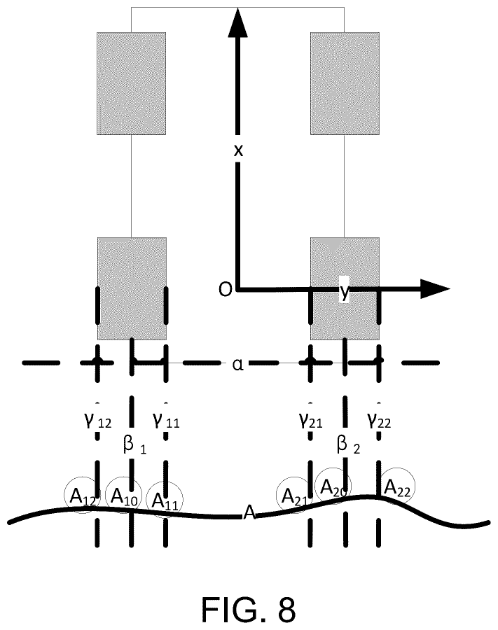

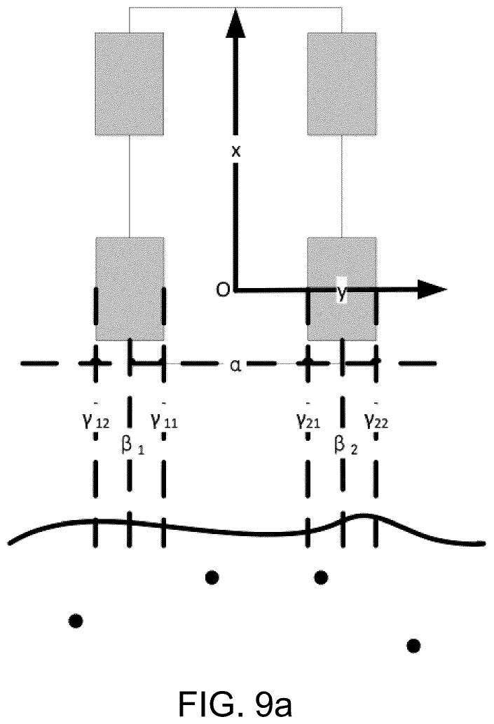

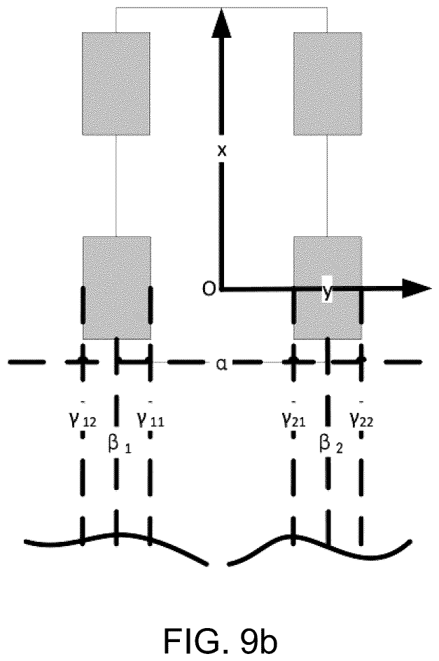

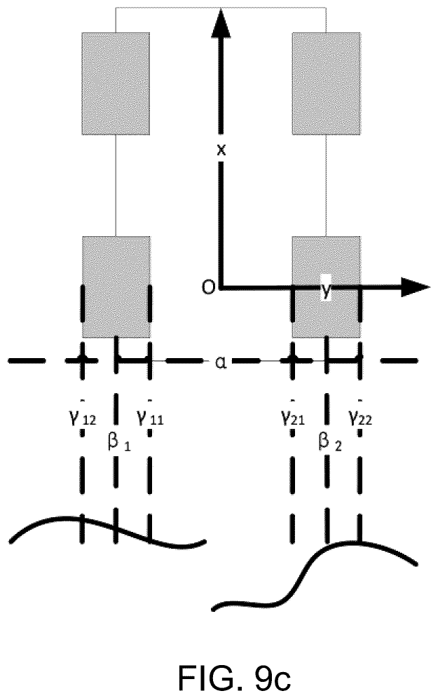

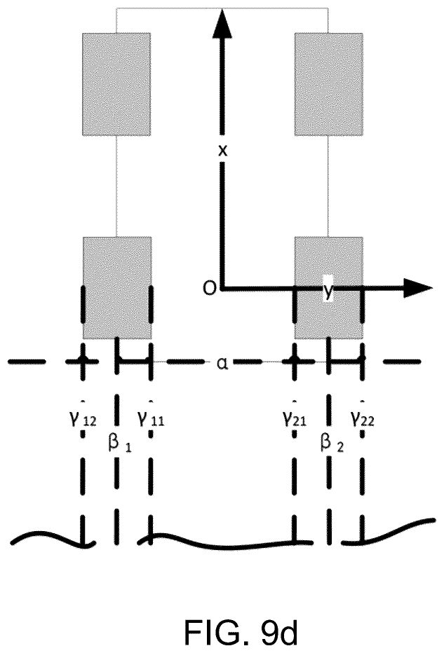

In FIG. 7, FIG. 8, FIG. 9 (a), FIG. 9 (b), FIG. 9 (c) and FIG. 9 (d), the method for calculating the distance information between the rear end of the vehicle and the retaining wall and the method for determining the integrity of the retaining wall behind the vehicle are depicted from an overhead view: the vehicle coordinate system is created based on a right-hand rule, with an x-axis pointing to the front of the vehicle and a y-axis pointing to the right side of the vehicle; the white box indicates the vehicle body, the gray boxes indicate wheels of the vehicle, the black dotted lines indicate the necessary geometric elements (planes) created by the data processing submodule, and the black line indicates the well-ordered set A created by the data processing submodule.

As shown in FIG. 5, FIG. 7 and FIG. 8, in one embodiment of the invention, the data processing submodule creates the following planes according to the size parameters of the vehicle:
First, a plane α located at the rear end of the vehicle and perpendicular to a chassis of the vehicle:
Second, a plane β₁ located at the center of a rear left wheel of the vehicle and perpendicular to a rear axle of the vehicle;
Third, a plane β₂ located at the center of a rear right wheel of the vehicle and perpendicular to the rear axle of the vehicle;
Fourth, a plane γ₁₁ located on an inner side of the rear left wheel of the vehicle and perpendicular to the rear axle of the vehicle;
Fifth, a plane γ₁₂ located on an outer side of the rear left wheel of the vehicle and perpendicular to the rear axle of the vehicle;
Sixth, a plane γ₂₁ located on an inner side of the rear right wheel of the vehicle and perpendicular to the rear axle of the vehicle; and
Seventh, a plane γ₂₂ located on an outer side of the rear right wheel of the vehicle and perpendicular to the rear axle of the vehicle.

As shown in FIG. 5, FIG. 9(a), FIG. 9(b), FIG. 9(c) and FIG. 9(d), in one embodiment of the invention, the distance information between the rear end of the vehicle and the retaining wall calculated by the distance calculation submodule may comprise the following five aspects:
First, the distance from the rear right wheel of the vehicle to the retaining wall;
Second, the minimum distance from the rear right wheel of the vehicle to the retaining wall;
Third, the minimum distance from the rear end of the vehicle to the retaining wall;
Fourth, the minimum distance from the rear left wheel of the vehicle to the retaining wall;
Fifth, the distance from the rear left wheel of the vehicle to the retaining wall.

Further, the distance calculation submodule may calculate the distance information between the rear end of the vehicle and the retaining wall as follows:

First, in one embodiment of the invention, the distance from the rear right wheel of the vehicle to the retaining wall is calculated by: first, obtaining A₂₀=β₂∩A (searching out a point nearest the plane β₂ from A to obtain A₂₀); and then, calculating the distance between A₂₀ and the plane α.

Second, in one embodiment of the invention, the minimum distance from the rear right wheel of the vehicle to the retaining wall is calculated by: first, obtaining A₂₁=γ₂₁∩A (searching out a point nearest the plane γ₂₁ from A to obtain A₂₁) and A₂₁ (searching out a point nearest the plane γ₂₂ from A to obtain A₂₂); then, selecting points between A₂₁ and A₂₂ from A to obtain a point list A₀; and finally, searching out a point nearest the plane α from A₀, and calculating the distance between the point and the plane α.

Third, in one embodiment of the invention, the minimum distance from the rear end of the vehicle to the retaining wall is calculated by: searching out a point nearest the plane α from A, and calculating the distance between the point and the plane α.

Fourth, in one embodiment of the invention, the minimum distance from the rear left wheel of the vehicle and the retaining wall is calculated by: first, obtaining A₁₁=γ₁₁∩A (searching out a point nearest the plane γ₁₁ from A to obtain A₁₁) and A₁₂=γ₁₂∩A (searching out a point nearest the plane γ₁₂ from A to obtain A₁₂); then, selecting points between A₁₁ and A₁₂ from A to obtain a point list A₀; and finally, searching out a point nearest the plane α from A₀, and calculating the distance between the point and the plane α.

Fifth, in one embodiment of the invention, the distance from the rear left wheel of the vehicle and the retaining wall is calculated by: first, obtaining A₁₀=β₁∩A (searching out a point nearest to the plane β₁ from A to obtain A₁₀); and then, calculating the distance between A₁₀ and the plane α.

In one embodiment of the invention, the integrity determination submodule determines whether the retaining wall behind the vehicle is complete as follows:

First, points, with a distance to the plane α exceeding a certain range, in A are referred to as abnormal points, and as shown in FIG. 9a, although there are four abnormal points in A, the proportion of the abnormal points is small, so the retaining wall is determined as complete; (criterion 1)

Second, the abnormal points are eliminated from A to obtain an ordered set A₁; then, curve fitting is performed on A₁ in the plane of the vehicle coordinate system xOy to obtain a curve equation x=f(y)(y∈D_{f}); then, A₁ is projected onto the plane α to obtain an ordered set A₂, wherein D_{f} denotes a definition domain of a function corresponding to the curved equation x=f(y), which is the same below;

Third, as show in FIG. 9b, when ∃(y₁, y₂)⊂ [symbol] |f((y₁, y₂))=Ø, the mean square root of the distance between two adjacent points in A₂ exceeds the range of a set threshold, so the retaining wall is determined as incomplete; (criterion 2)

Fourth, as shown in FIG. 9c, when

$$∃ {y}_{0} ∈ {D}_{f} \vert {lim}_{y \to {y}_{0}^{+}} f ( y ) \neq {lim}_{y \to {y}_{0}^{-}} f ( y ) ,$$

wherein y₀ denotes a specific representative element in D_{f}, although criterion 2 is satisfied, the standard deviation of distances from points in A₁ to the plane α exceeds the range of a set threshold, so the retaining wall is determined as incomplete: (criterion 3)

Fifth, as shown in FIG. 9d, A₂ satisfies criterion 2, but (∀\vec{p}∈A₁|(∃ε>ε₁>0|D(\vec{p}₁,β₁)>ε))∨(∀\vec{p}∈A₁|(∃ε>ε₂>0|D(\vec{p},β₂)>ε)), wherein, ε₁(ε₂) denotes the range of a threshold set for the rear left (right) wheel of the vehicle, D(\vec{p},⋅) denotes the distance from the point \vec{p} to a plane, which indicates that the point \vec{p} does not exist in A₁ and the distance from the point \vec{p} to the plane β₁(β₂) is within the range of a threshold, so the retaining wall is still determined as incomplete. (criterion 4)

Correspondingly, the invention further provides a computer-readable storage medium having one or more programs stored therein, wherein the one or more programs comprise instructions, and when the instructions are executed by a computing device, the computing device implements any one of the methods as described above.

Correspondingly, the invention further provides a computing device, comprising:
one or more processors, a memory and one or more programs, wherein the one or more programs are stored in the memory and configured to be executed by the one or more processors and comprise instructions for implementing any one of the methods as described above.

Those skilled in the art should understand that the embodiments of the application can be provided as a method, system or computer program product. Therefore, the application can be implemented as pure hardware embodiments, pure software embodiments, or embodiments combining software and hardware. In addition, the application may be implemented as a computer program product executed on one or more computer-available storage media comprising computer-available program codes (including, but not limited to, a disk memory, a CD-ROM and an optical memory).

The application is described with reference to flow diagrams and/or block diagrams of the method, device (system) and computer program product in the embodiments of the application. It should be understood that each process and/or block in the flow diagrams and/or block diagrams and the combination of the processes and/or blocks in the flow diagrams and/or block diagrams can be implemented by means of computer program instructions. These computer program instructions may be provided in a general-purpose computer, a special-purpose computer, an embedded processor or a processor of other programmable data processing devices to create a machine, such that the instructions can be executed by the computer or the processor of other programmable data processing devices to produce a device for implementing one or more processes in the flow diagrams and/or functions specified in one or more blocks in the block diagrams.

These computer program instructions can also be stored in a computer-readable memory capable of guiding a computer or other programmable data processing devices to work in a specific manner, such that the instructions stored in the computer-readable memory can create a product comprising an instruction device for implementing one or more processes in the flow diagrams and/or functions specified in one or more blocks in the block diagrams.

These computer program instructions can also be loaded in a computer or other programmable data processing devices to allow a series of operation steps to be performed on the computer or other programmable data processing devices to realize computer processing, such that the instructions executed on the computer or other programmable data processing devices can perform steps for implementing one or more processes in the flow diagrams and/or functions specified in one or more blocks in the block diagrams.

Preferred embodiments of the invention are described above. It should be pointed out that those ordinarily skilled in the art can make some improvements and transformations without departing from the technical principle of the invention, and all these improvements and transformations should also fall within the protection scope of the invention.

1. A method for detecting a retaining wall suitable for an automatic driving vehicle, comprising:
obtaining original data acquired during a backing process of a vehicle and used for detecting a retaining wall, and processing the original data to obtain finally processed data of the retaining wall;
obtaining ground data during the backing process of the vehicle, and sequentially performing ground determination and ground elimination on the ground data to obtain non-ground point cloud data; and
obtaining distance information between a rear end of the vehicle and the retaining wall and integrity data of the retaining wall by calculation according to the finally processed data of the retaining wall and the non-ground point cloud data.

2. The method for detecting the retaining wall suitable for the automatic driving vehicle according to claim 1, wherein the original data include attitude information and motion state information of the vehicle and point cloud data related to the retaining wall behind the automatic driving vehicle.

3. The method for detecting the retaining wall suitable for the automatic driving vehicle according to claim 2, wherein processing the original data comprises:
determining whether a distance from a coordinate of a point in point cloud data to a coordinate origin is less than a preset distance; if so, determining the point indicated by the coordinate as an invalid point that needs to be filtered out; otherwise, determining the point indicated by the coordinate as a valid point that needs to be reserved;
performing dilation transformation on coordinates of data obtained after invalid points are filtered out;
performing orthogonal transformation on the data subjected to the dilation transformation to transform a reference system of the data subjected to the dilation transformation from a sensor coordinate system to a vehicle coordinate system;
determining, according to size parameters of the vehicle, whether a coordinate of a point after the orthogonal transformation belongs to a vehicle body; if so, determining the point indicated by the coordinate as an invalid point that needs to be filtered out; otherwise, determining the point indicated by the coordinate is a valid point that needs to be reserved; and
determining whether a point left after invalid points belonging to the vehicle body are filtered out is a noisy point according to a change in attribute of the point; if so, filtering out of the noisy point, thus obtaining the final processed data of the retaining wall.

4. The method for detecting the retaining wall suitable for the automatic driving vehicle according to claim 2, wherein sequentially performing the ground determination and the ground elimination on the ground data to obtain the non-ground point cloud data comprises:
sequentially obtaining geometric features of an area where projections on a ground of points in the point cloud are located according to the ground data, and determining whether the points are ground points according to the geometric features of the area; if so, filtering out of the points; otherwise, reserving the points, thus obtaining point cloud data of non-ground point information; and
constructing and outputting the non-ground point cloud data according to the point cloud data of the non-ground point information.

5. The method for detecting the retaining wall suitable for the automatic driving vehicle according to claim 1, wherein obtaining the distance information between the rear end of the vehicle and the retaining wall and the integrity data of the retaining wall by calculation according to the finally processed data of the retaining wall and the non-ground point cloud data comprises:
converting the non-ground point cloud data into a well-ordered set according to a preset well-ordered relationship, and creating necessary geometric elements according to the finally processed data of the retaining wall and size parameters of the vehicle;
calculating the distance information between the rear end of the vehicle and the retaining wall according to the well-ordered set and the necessary geometric elements; and
determining the integrity data of the retaining wall behind the vehicle according to the well-ordered set, the necessary geometric elements and the distance information between the rear end of the vehicle and the retaining wall.

6. The method for detecting the retaining wall suitable for the automatic driving vehicle according to claim 5, wherein the well-ordered relationship is expressed as:
$${\vec{p}}_{1} > {\vec{p}}_{2} ⇔ ( sign ( ( {\vec{p}}_{1} \times {\vec{p}}_{2} ) \vert z ) 〈 {\vec{p}}_{1} , {\vec{p}}_{2} 〉 > 0 ) ⋁ ( ( {\vec{p}}_{1} \times {\vec{p}}_{2} = \vec{0} ) ∧ ( \vert {\vec{p}}_{1} \vert > \vert {\vec{p}}_{2} \vert ) )$$
$$wherein ,$$
$$sign ( x ) = \{ \begin{matrix}1 & x \geq 0 \\ - 1 & x < 0\end{matrix}$$
where, \vec{p}₁ and \vec{p}₂ denote position vectors corresponding to coordinates of any two points in the point cloud, z denotes a Z-axis, \vec{0} denotes a zero vector, x is an independent variable, and x=(\vec{p}₁×\vec{p}₂)|z.

7. The method for detecting the retaining wall suitable for the automatic driving vehicle according to claim 6, wherein the necessary geometric elements comprise:
a plane α located at the rear end of the vehicle and perpendicular to a chassis of the vehicle;
a plane β₁ located at a center of a rear left wheel of the vehicle and perpendicular to a rear axle of the vehicle;
a plane β₂ located at a center of a rear right wheel of the vehicle and perpendicular to the rear axle of the vehicle;
a plane γ₁₁ located on an inner side of the rear left wheel of the vehicle and perpendicular to the rear axle of the vehicle;
a plane γ₁₂ located on an outer side of the rear left wheel of the vehicle and perpendicular to the rear axle of the vehicle;
a plane γ₂₁ located on an inner side of the rear right wheel of the vehicle and perpendicular to the rear axle of the vehicle; and
a plane γ₂₂ located on an outer side of the rear right wheel of the vehicle and perpendicular to the rear axle of the vehicle.

8. The method for detecting the retaining wall suitable for the automatic driving vehicle according to claim 7, wherein calculating the distance information between the rear end of the vehicle and the retaining wall according to the well-ordered set and the necessary geometric elements comprises:
searching out a point nearest the plane β₂ from the well-ordered set, and calculating a distance between the point and the plane α to obtain a distance from the rear right wheel of the vehicle to the retaining wall;
selecting points between the plane γ₂₁ and the plane γ₂₂ from the well-ordered set, then searching out a point nearest the plane α from the selected points, and calculating a distance between the point and the plane α to obtain a minimum distance from the rear right wheel of the vehicle to the retaining wall;
searching out a point nearest the plane α from the well-ordered set, and calculating a distance between the point and the plane α to obtain a distance from the rear end of the vehicle to the retaining wall;
selecting points between the plane γ₁₁ and the plane γ₁₂ from the well-ordered set, then searching out a point nearest the plane α from the selected points, and calculating a distance between the point and the plane α to obtain a minimum distance from the rear left wheel of the vehicle to the retaining wall; and
searching out a point nearest the plane β₁ from the well-ordered set, and calculating a distance between the point and the plane α to obtain a distance from the rear left wheel of the vehicle to the retaining wall.

9. The method for detecting the retaining wall suitable for the automatic driving vehicle according to claim 8, wherein determining the integrity data of the retaining wall behind the vehicle according to the well-ordered set, the necessary geometric elements and the distance information between the rear end of the vehicle and the retaining wall comprises:
determining points, with a distance to the plane α exceeding a first preset threshold, in the well-ordered set as abnormal points, calculating the proportion of the abnormal points in all points in the well-ordered set, and determining according to a first criterion, the first criterion is: if the proportion is greater than a preset proportion threshold, determining the retaining wall as incomplete; if the proportion is not greater than the preset proportion threshold, eliminating the abnormal points from the well-ordered set;
after the abnormal points are eliminated, determining according to a second criterion, a third criterion and a fourth criterion;
the second criterion: determining whether a mean square root of a distance between projections, on the plane α, of two adjacent points in the well-ordered set is within the range of a second preset threshold;
the third criterion: determining whether a standard deviation of distances from all the points in the well-ordered set to the plane α is within a third preset threshold;
the fourth criterion: determining whether there are points, with a distance therebetween within the range of a fourth preset threshold, on two sides of the plane β₁ and two sides of the plane β₂; and
determining the retaining wall as complete when the proportion of the abnormal points is not greater than the preset proportion threshold and the second criterion, the third criterion and the fourth criterion are satisfied.

10. A system for detecting a retaining wall suitable for an automatic driving vehicle, comprising:
a data acquisition module used for obtaining original data acquired during a backing process of a vehicle and used for detecting a retaining wall, and processing the original data to obtain finally processed data of the retaining wall;
a data screening module used for obtaining ground data during the backing process of the vehicle, and sequentially performing ground determination and ground elimination on the ground data to obtain non-ground point cloud data; and
a feature extraction module used for obtaining distance information between a rear end of the vehicle and the retaining wall and integrity data of the retaining wall by calculation according to the finally processed data of the retaining wall and the non-ground point cloud data.
